(19) United States
(12) Patent Application Publication
(10) Pub. No.: US 2025/0197141 A1
(43) Pub. Date: Jun. 19, 2025

(54) PORTABLE AND ADAPTABLE MATERIAL HANDING AUTONOMOUS GUIDED VEHICLE FOR TEMPORARY JOB SITES, SUCH AS FOR USE WITH AUTOMATED WHEELBARROW LIFTS, RELATED SYSTEMS AND METHODS

(71) Applicants: Eric Mackintosh, Tyler, TX (US); Heath Hicks, Tyler, TX (US)

(72) Inventors: Eric Mackintosh, Tyler, TX (US); Heath Hicks, Tyler, TX (US)

(21) Appl. No.: 19/062,406

(22) Filed: Feb. 25, 2025

Related U.S. Application Data
(63) Continuation-in-part of application No. 18/660,425, filed on May 10, 2024.
Application No. 18/660,425 is a continuation-in-part of application No. PCT/US2023/086189, filed on Dec. 28, 2023.
(63) Continuation-in-part of application No. PCT/US2023/086189, filed on Dec. 28, 2023.
(60) Provisional application No. 63/435,841, filed on Dec. 29, 2022.
(60) Provisional application No. 63/558,284, filed on Feb. 27, 2024.

(51) Int. Cl. B65G 67/46; B65F 1/14; G05D 1/244; G05D 1/667; G05D 107/90; G05D 109/10

(52) U.S. Cl. CPC B65G 67/46; B65F 1/1452; G05D 1/244; G05D 1/667; G05D 2107/90; G05D 2109/10

(57) ABSTRACT

Portable and adaptable material handling autonomous guided vehicle (“AGV”) for temporary job sites are disclosed, along with related systems and methods. The AGV may include wheels, a deck, a compartment for receiving materials, and attachment component(s) for detachably securing the compartment to the deck. The AGV may be guided to and/or docked with a docking portion of a motorized and/or automated lift for dumping the materials from the detachable compartment into a dumpster. The AGV may be guided by sensing of temporary navigational markers placed about obstacles at the job site.

### CROSS-REFERENCE TO RELATED APPLICATIONS

This application is a continuation-in-part of U.S. application Ser. No. 18/660,425 filed May 10, 2024, which is a continuation-in-part of PCT/US2023/086189 filed internationally on Dec. 28, 2023, which claims the benefit of U.S. Provisional Application Ser. No. 63/435,841 filed Dec. 29, 2022; this application also claims the benefit of U.S. Provisional Application Ser. No. 63/558,284 filed Feb. 27, 2024; this application is also a continuation-in-part of PCT/US2023/086189 filed internationally on Dec. 28, 2023; the disclosures of each of the foregoing are hereby incorporated by reference as if fully restated herein.

### TECHNICAL FIELD

Exemplary embodiments relate generally to an autonomous guided vehicle (AGV) which is portable and adaptable, such as for use at temporary job sites, such as for use with automated wheelbarrow lifts, as well as related systems and methods.

### BACKGROUND AND SUMMARY OF THE INVENTION

Wheelbarrows are sometimes used to load debris or other materials, such as waste, at a job site. Such material is sometimes deposited into a dumpster, such as by manually transferring the material by hand or shovel. This effort is relatively labor intensive as it generally involves repeatedly lifting relatively small quantities of the material a significant distance. Alternatively, a forward portion or door into the dumpster is opened to deposit material, but this prevents the full space of the dumpster from being utilized, else the material will spill out. What is needed is a device for assisting with deposit of material from a wheelbarrow into a dumpster.

A wheelbarrow lift for a dumpster or other container and related systems and methods are provided. A lift may be provided at the dumpster or other container. A wheelbarrow may be loaded with waste material and docked with the lift. For example, without limitation, the lift may include a platform with an opening shaped to accommodate and secure a tub of the wheelbarrow. However, the platform may be adapted to accommodate other types or kinds of wheelbarrows or other material transportation vehicles. The platform with the docked wheelbarrow may be lifted, such as by way of one or more motors, along the track which may vertically raise and rotate the platform and docked wheelbarrow to dump the waste material into the dumpster. The wheelbarrow may be lowered so that it may be undocked and reloaded. In this fashion, material deposited in wheelbarrows may be quickly and efficiently transferred to a dumpster.

A significant amount of time and other resources are often occupied with moving materials about a job site. For example, lumber may need moved from a drop point to an installation site. As another example, trash or other debris may need moved from one a point of generation to a dumpster. Typically, such movement is accomplished by manual labor (e.g., hand carrying, wheelbarrows, and/or other hand carts).

Autonomous guided vehicles (AGVs) are known. Typically, such AGV are adapted for work at a relatively permanent job site, such as a factory. The physical configuration and programming of such AGVs are generally adapted for work in such relatively fixed environments, which are also relatively adapted to work with such AGVs. Such AGVs are not traditionally well adapted for work at temporary job sites, such as construction sites.

What is needed is an AGV adapted for work at a temporary job site. Portable and/or adaptable material handling AGVs are disclosed which are well suited for operations at a temporary job site, such as a construction site, along with systems and/or methods for the same.

The AGV may comprise one or more detachable material storage compartments, which may be attachable by way of magnets, hooks, mating protrusions and recesses, threaded fasteners, pins and apertures, clamps, combinations thereof, or the like. The compartments may be detached upon docking of the AGV with the dumpster lift, by way of example. This may allow the compartment to be separately lifted and the material (e.g., trash) loaded therein to be dumped, thereby reducing lifting capacity needs and/or wear and tear for the lift. This may also allow various size, shape, and/or types of compartments to be loaded, such as for accommodating various types and/or kinds of materials (e.g., trash for dumping, tools and/or construction materials for delivery, etc.). This may also allow the AGV to work with automated or mechanized lifts for such dumpsters or other waste receptacles, such as so the lift does not need to lift the entire weight of the AGV, just that of the container and loaded material. This allows for more efficient lifting and less wear and tear on the lift. The AGV and/or lift may include sensors for detecting the docking of the AGV with the lift, which may trigger release of the compartments, such as by way of a controller local to the AGV. Alternatively, or additionally, release may be performed manually.

The AGV may be configured to navigate using temporary path indicators at the job site. Such temporary indicators may include tape, stickers, or other substrates (e.g., puck, medallion, or the like). The temporary indicators may be included, such as by color and/or symbol. Sensors may be provided at the AGV to detect the temporary indicators and their encoding. Preferably, the AGV includes a series of downward facing optical sensors. The AGV may be programmed with the symbols and may be configured to navigate according to the temporary indicators sensed (e.g., certain colors/symbols indicating direction, speed, next action, etc.; direction or orientation or markers indicating desired direction of travel). In this fashion, the desired navigational pathway may be quickly and easily installed, removed, and/or updated, which may be particularly useful for temporary job sites.

The AGV may additionally, or alternatively, comprise various sensors for autonomous, or semi-autonomous movement (e.g., cameras, machine vision software, proximity sensors, range finders, LiDAR, GPS, combinations thereof, or the like). Such sensor(s) may be generally outward directed (e.g., forward, rearward, sides, etc.). The AGV may additionally be preprogrammed, at least in part, to follow a predetermined path. Such autonomous or semi-autonomous and/or preprogrammed navigation may be used as an alternative to and/or to enhance the guided navigation and/or where unexpected conditions are encountered (e.g., obstacles, lack of temporary marker, etc.), which may occur more frequently at temporary job sites.

The AGV may be provided with various ruggedization features, such to enhance suitability for temporary construction sites which may be outdoors or otherwise have rough terrain. Such features may include, for example without limitation, wheels, tracks, shocks, sealed or partially sealed electronics and/or power supply compartments, combinations thereof, or the like.

The AGV preferably is battery powered, supplied by wired and/or wireless charging, however, other fuel supplies may be utilized.

The AGV may be configured to communicate with elevator and/or gate control systems, for example, such as to better navigate a job site.

The AGV and/or storage compartments thereof may include one or more structural features adapted to dock with the dumpster lift. Such features may comprise, by way of non-limiting example, protrusions, struts, slots, combinations thereof, or the like.

The AGV may be transportable between job sites, such as in a full-size pickup truck bed, though such is not required. Various size, shape, and/or weight AGVs which are transportable by various size, shape and/or type of vehicles may be utilized.

Further features and advantages of the systems and methods disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a perspective view of a dumpster deposit system with a loaded wheelbarrow being docked;

FIG. 2 is the system of FIG. 1 with the docked wheelbarrow vertically raised and rotated and dumping the debris into a dumpster;

FIG. 3 is a side view of the lift of FIGS. 1-2 illustrated in isolation;

FIG. 4 is a side view of another exemplary embodiment of the lift of FIG. 3;

FIG. 5 is a side view of another exemplary embodiment of the lift of FIG. 3;

FIG. 6 is a plan view of an exemplary system for operating the lift of FIGS. 1-5;

FIG. 7 is a flow chart with exemplary logic for operating the system and/or lift of FIGS. 1-6;

FIG. 8 illustrates a perspective view of another exemplary embodiment of the docking portion of the system and/or lift of FIGS. 1-7 illustrated in isolation;

FIG. 9 is a perspective view of another exemplary embodiment of the dumpster deposit system of FIG. 1;

FIG. 10 is a detailed perspective view of Detail A of FIG. 9;

FIG. 11 is a side, perspective view of another exemplary embodiment of the system and/or lift in exemplary use;

FIG. 12 is a detailed side view of the system and/or lift of FIG. 11;

FIG. 13 is a side, perspective view of the system and/or lift of FIG. 11 in further exemplary use;

FIG. 14 is a side, perspective view of the system and/or lift of FIG. 11 in further exemplary use;

FIG. 15 is a schematic side view of an exemplary embodiment of the system and/or lift of FIGS. 1-14

FIG. 16 is a side view of an exemplary AGV adapted for use at a temporary job site, such as with the system and/or lift of FIG. 1-15;

FIG. 17 is a perspective view of another exemplary AGV adapted for use at a temporary job site, such as with the system and/or lift of FIG. 1-15, with a detachable storage compartment detached; and

FIG. 18 is an exemplary plan view of the AGV in exemplary at an exemplary temporary job site with the system and/or lift of one or more of FIGS. 1-15.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

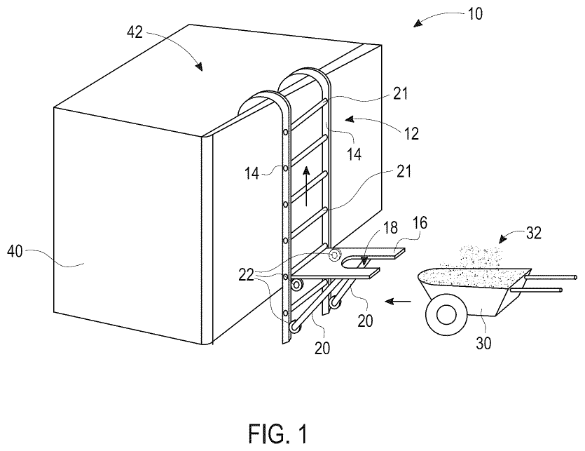

FIG. 1 illustrates an exemplary system 10 for depositing debris 32 from a wheelbarrow 30 into a dumpster 40. The system 10 may comprise a lift 12. The lift 12 may be independent from, and removably attachable to, the dumpster 40. For example, without limitation, the lift 12 may comprise one or more tracks 14. At least an upper portion of the tracks 14 may be configured to hook over an upper edge of the dumpster 40, such as to be secured by gravitational and/or frictional forces. A relatively high friction material (e.g., rubber) may be provided on the undersides of the tracks 14. Alternatively, the lift 12 may be permanently or semi-permanently attached to the dumpster 40. For example, without limitation, one or more portions of the tracks 14 may be clamped, welded, fastened, or otherwise secured to one or more walls of the dumpster 40.

The tracks 14 may comprise vertically extending portions, which may extend vertically along a forward wall of the dumpster 40, by way of non-limiting example. The vertically extending portions of the tracks 14 may extend an entire or partial vertical height of the dumpster. For example, they may extend to or near a bottom surface of the dumpster 40, which is presumably adjacent to a ground surface, or be spaced apart therefrom. The upper portions of the tracks 14 may be configured to hook or otherwise extend over an upper wall or portion of the dumpster 40, such as into an upper or other opening 42 thereof. Two tracks 14 may be provided. The tracks 14 may be spaced apart from one another and may extend substantially or entirely parallel to one another, such as at a fixed spacing. Any number, type, and/or arrangement of tracks 14 may be utilized. The tracks 14 may be sized and/or configured to accommodate various size, shape and/or type dumpsters 40, such as with various size, shape, number, type, and/or location of opening 42.

The lift 12 may comprise a docking portion 16. The docking portion 16 may comprise one or more platforms or other surfaces. The docking portion 16 may comprise one or more docking apertures 18. The docking portion 16 may be configured to permit horizontal movement of the wheelbarrow 30 along a ground surface for securement within the aperture 18 when the docking portion 16 is at a first, lowered position, by way of non-limiting example.

The apertures 18 may be provided, such as in the platforms or other surfaces, and may be sized, shaped, and/or otherwise configured to accommodate a portion of the wheelbarrow 30. In exemplary embodiments, without limitation, the aperture 18 may be sized such as to receive a tub portion of the wheelbarrow 30. The aperture 18 may be sized such that the wheelbarrow 30 is frictionally engaged as the docking portion 16 is raised relative to the wheelbarrow 30. For example, without limitation, conventionally, the upper portions of a wheelbarrow 30 tub are larger than the lower portions, thus the aperture 18 may be sized to fit at a middle and/or upper portion of the tub for the wheelbarrow 30 while preventing the wheelbarrow 30 from slipping therethrough. The aperture 18 may be lined with a cushioned and/or grippy material, such as but not limited to foam or rubber.

Other size and shape apertures 18 may be provided for other size, shape, and/or types of wheelbarrows 30 or other material transport vehicles. The aperture 18 may be configured to provide a snug fit to the wheelbarrows 30 or other material transport vehicles and may be configured to prevent vertical and/or limited lateral movement (e.g., in a particular direction or without significant outside forces) of the wheelbarrows 30 or other material transport vehicles when secured at the apertures 18. For example, the aperture 18 may be configured to allow the wheelbarrows 30 or other material transport vehicles to be moved laterally into or out of the aperture 18 but prevent vertical movement and movement in a forward direction when docked. In this fashion, the wheelbarrows 30 or other material transport vehicles may be lifted and/or rotated vertically (or beyond vertically) to dump the material 32 without undocking.

The docking portion 16 may comprise one or more secondary securing devices, such as but not limited to, clips, straps, clamps, wheel blocks, wheel grooves, fasteners, combinations thereof, or the like for securing or further securing the wheelbarrow 30 or other material transport vehicles to the docking portion 16. Any type, kind, number, and/or arrangement of such secondary securing devices may be utilized for any type and/or kind of wheelbarrow 30 or other material transport vehicle.

The docking portion 16 may be secured to the tracks 14 by way of wheels 22, such as to permit movement of the docking portion 16 along the tracks 14.

The docking portion 16 may comprise one or more support members 20. The support members 20 may provide structural rigidity to the docking portion 16. Wheels 22 may be provided at the support members 20, though such is not required. The wheels 22 may ride within interior facing side portions of the tracks 14, exterior facing side portions of the track, front facing exterior portions of the tracks 14, combinations thereof, or the like. In this way, the tracks 14 may act like rails which guide and/or constrain wheel 22 movement. The wheels 22 and/or tracks 14, for example without limitation, may be adapted to mutually receive and/or constrain one another (e.g., corresponding protrusions and grooves). Any number, size, type, and/or arrangement of support member 20 may be utilized. Any number, size, type, and/or arrangement of wheels 22 may be utilized.

One or more cross supports 21 may extend between the tracks 14 for added support. The cross supports 21 may be located near a rear of the track 14, in exemplary embodiments without limitation, such as to accommodate the wheels 22. Other arrangements for accommodating the wheels 22 may be utilized. Any number, size, type, and/or arrangement of cross supports 21 may be utilized.

The dumpster 40 may be configured for lifting and dumping itself, such as when it is full or otherwise in need of emptied.

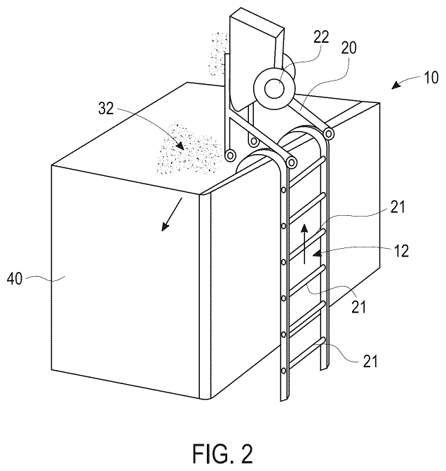

FIG. 2 illustrates the system 10 with a wheelbarrow 30 docked, raised, and rotated to deposit debris 32 into the dumpster 40. The vertically extending portions of the track(s) 14 may be configured to permit vertical raising of the wheelbarrow 30 when docked. The curved upper portions of the track(s) 14 may be configured to force rotation of the wheelbarrow 30, such as to a vertical) (˜90°), near vertical (e.g., between about 65-90°), or beyond vertical (e.g., between about 90°-180°), when raised to deposit the debris 32 within the dumpster 40. In this fashion, the material 32 is dumped forward out of the wheelbarrow 30.

Any shape or arrangement of the tracks 14 may be utilized. For example, without limitation, the tracks 14 may be configured to provide a full or partial barrel roll type inversion to the wheelbarrow 30, a side dump, combinations thereof, or the like.

Alternatively, or additionally, the docking portion 16 may comprise one or more mechanisms for lifting the wheelbarrow 30 to dump the material 32 once the docking portion 16 is raised. Such mechanisms may include, for example without limitation, ramps, pistons, hinges, pulleys, or the like for tilting the wheelbarrow 30, which remains otherwise secured.

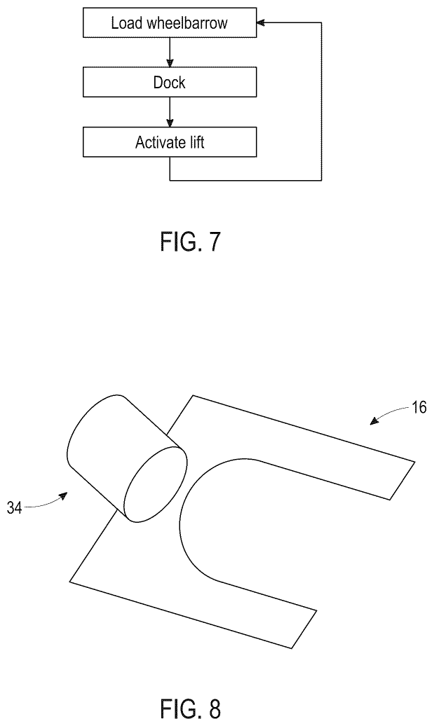

As demonstrated in at least FIG. 7, the wheelbarrow 30 may be subsequently returned to a lowered position to be undocked and refilled.

While wheelbarrows 30 may be shown and/or described in certain instances, other types and/or kinds of vehicles for material transportation may be utilized, which are configured to manual and/or automatic movement, such as but not limited to wagons, hand carts, trolleys, combinations thereof, or the like. Elements of the lift 12 may be adapted to accommodate such vehicles, such as by providing an appropriately sized, shaped, and/or otherwise configured platforms or other surfaces of the docking portion 16. For example, without limitation, the docking portion may comprise one or more flat surfaces for rolling the vehicles onto and/or securing the vehicle. Alternatively, or additionally, the docking portion 16 may comprise one or more containers and the debris 32 may be manually dumped into the container by the wheelbarrow 30 or other vehicle for lifting.

While dumpsters 40 may be shown and/or described in certain instances, other types and/or kinds of waste receptacles may be utilized. Elements of the lift 12 may be adapted to accommodate such waste receptacles, such as by providing appropriately sized, shaped, and/or otherwise configured track(s) 14.

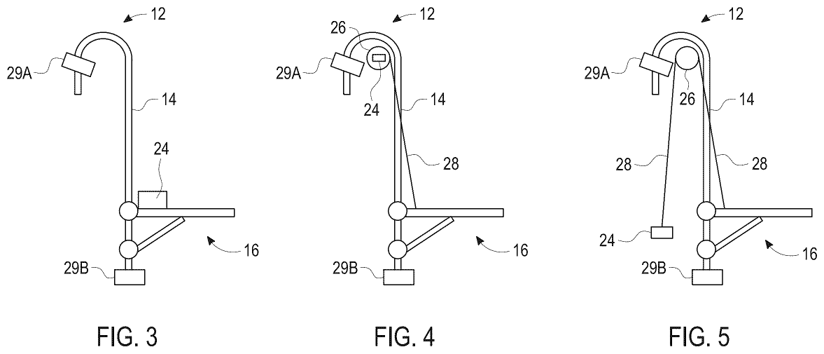

FIG. 3 illustrates an exemplary embodiment of the lift 12. The lift 12 may comprise one or more stoppers 29. A first set of one or more stoppers 29A may be positioned along or at an upper portion of the track(s) 14 to prevent movement of the docking portion 16 beyond a first end of the track 14. A respective one of the first set of stoppers 29A may be provided at each of the tracks 14. A second set of one or more stoppers 29B may be positioned along or at a lower portion of the track(s) 14 to prevent movement of the docking portion 16 beyond a second end of the track 14. A respective one of the second set of stoppers 29B may be provided at each of the tracks 14.

The stoppers 29 may comprise blocks, crimped track ends, combinations thereof, or the like. Any number, type, and/or placement of stoppers 29 may be utilized. The use of stoppers 29 is optional. For example, the docking portion 16 may be otherwise electronically controlled to prevent movement beyond the tracks 14.

One or more motors 24 may be provided at the docking portion 16. The motors 24 may be configured to directly or indirectly (e.g., by drive shafts, gears, chains, cams, linkages, ropes, wires, combination thereof, or the like) drive the wheels 22. A respective motor 24 may be provided for each respective wheel 22 and/or a common motor 24 may be provided for multiple wheels 22. Some or all wheels 22 may be motorized.

FIG. 4 illustrates another exemplary embodiment of the lift 12 whereby one or more flexible linkages 28, such as but not limited to, rope, wire, cable, chain, combinations thereof, or the like, are attached to the docking portion 16 and connected to a movement redirection component 26, such as but not limited to a gear, pulley, block, tackle, spool, combination thereof, or the like. The movement redirection component 26 may be configured for motorized operation by a motor 24. Multiple flexible linkages 28, movement redirection component 26 and/or, motors 24 may be utilized. Intervening components such as but not limited to levers, gears, cams, pulleys, combination thereof, or the like may be utilized, such as to provide mechanical advantages. The redirection component 26 may be provided with the motor 24, such as to form and/or as part of a winch, by way of non-limiting example.

FIG. 5 illustrates another exemplary embodiment of the lift 12 whereby the one or more flexible linkages 28 may extend about some or all of the movement redirection component(s) 26 to a ground surface where the motor 24 is provided.

A single or multiple motors 24, movement redirection components 26, flexible linkages 28, combinations thereof, or the like may be utilized together and/or separately such as to provide additional power, capacity, and/or mechanical advantage.

Alternatively, or additionally, the lift 12 may be configured for manually lifting of the docking portion 16 and any docked wheelbarrows 30. The same or similar arrangements as provided in any or all of FIGS. 3-5 may be utilized, such as separately and/or together, but may, alternatively or additionally, include one or more devices for imparting mechanical advantages, such as, but not limited to, counterweights, pulleys, block and tackle, gears, levers, combinations thereof, or the like. For example, without limitation, a counterweight may be used in place of the motor 24 of FIG. 5. As another example, without limitation, the movement redirection component 26 of FIG. 4 may comprise a spring or other component for assisting with moving the docking portion 16 along the track(s) 14.

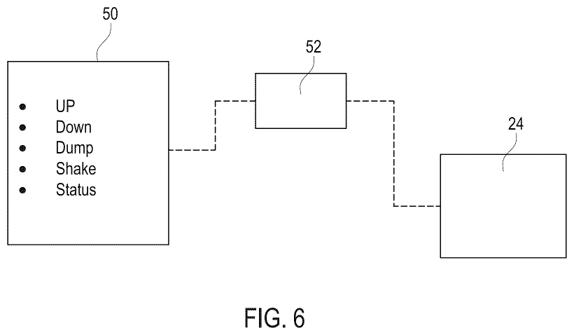

As illustrated in FIG. 6 the motor(s) 24 may be operated by one or more controllers 52, which may be local to, or remote from, the motors 24 and/or lift 12. The controllers 52 may be in electronic communication with user interfaces 50. The user interfaces 50 may be configured to display information regarding lift 12 status and/or accept commands for lift 12 operation, such as to move the docking portion 16 up or down, to dump a load, to shake the wheelbarrow 30 (e.g., rapid, short distance movement of the docking portion 16 along the tracks 14) such as to dislodge any remaining debris 32, and/or display status of the lift 12 by way of non-limiting example. The user interfaces 50 may comprise electronic displays, depressible buttons, touch screens, combinations thereof, or the like. The user interfaces 50 may be local to, or remote from, the controllers 52, the motors 24 and/or lift 12. The controllers 52 may comprise software for providing and/or accepting commands from the user interfaces 50 and operating the motors 24. The user interfaces 50 may be provided at one or more personal electronic devices, such as smartphone, tablets, or the like.

As illustrated in FIG. 8, the docking portion 16 may comprise one or more debris directors 34. The debris directors 34 may comprise a chute, panel, defector, combinations thereof, or the like configured to direct the debris 32 as they exit the wheelbarrow 30 and enter the dumpster 40. In this fashion, the debris 32 may be directed within the dumpster 40, such as into different compartments or areas thereof. This may be useful, for example without limitation, separating different types of debris 32 and/or directing the debris 32 to less full areas to fill the dumpster 40. The debris directors 34 may be rotatable or moveable to so direct the debris 32. For example, without limitation, the debris director 34 may comprise a chute which is rotatably mounted to the surfaces or platforms of the docking portion 16, such as by way of one or more ball bearings.

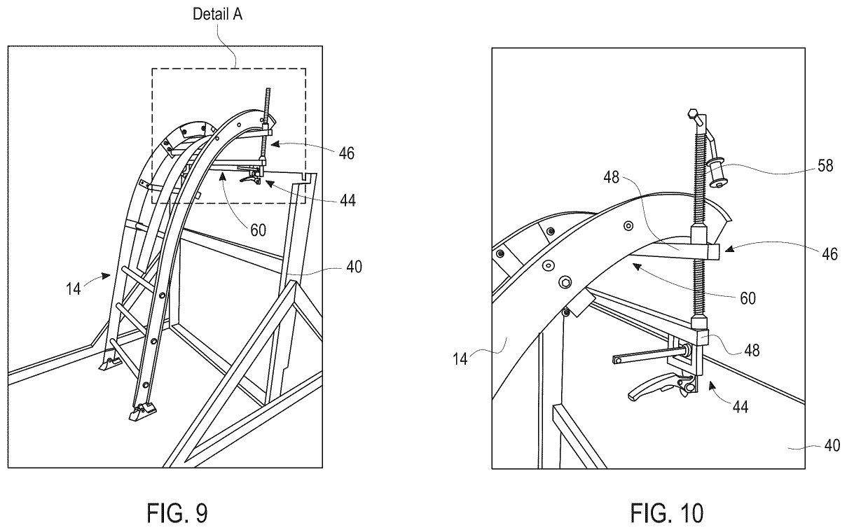

As illustrated with particular regard to FIG. 9 and FIG. 10, the tracks 14 may be configured to clamp onto or otherwise be secured to a portion of the dumpster 40, such as the upper edge thereof, such as by their shape. For example, without limitation, clamping devices 44 may be provided for assisting in such securement. Alternatively, or additionally, one or more height adjustment mechanisms 46 may be provided to for adjusting the lift 12 to various size dumpsters 40. In exemplary embodiments, without limitation, the height adjustment mechanism(s) 46 may comprise a bracket 48. The bracket 48 may comprise one or more members. The bracket 48 may be connected to the dumpster 40, such as an upper edge of thereof, by way of one or more clamps 44. The bracket 48 may be adjustable by vertical members 58, such as but not limited to, threaded rods, telescoping rods, scissor lifts, jacks, pneumatic lifts, linear actuators, combinations thereof, or the like, which may be configured to provide various amounts of separation between the members of the bracket 48, such as to adjust a height of the track 14. Handles or the like may be provided at, or in association with, the vertical members 58 to effectuate movement. Alternatively, or additionally, controls for the height adjustment mechanism(s) 46 and/or the clamping devices 44 may be provided at the user interface 50 and controlled electronically by the controller 52.

In exemplary embodiments, without limitation, the upper portion of the track 14 may have a decreasing radius, as generally indicated at item 60, such as to allow more efficient operation of the motor(s) 24.

Notably, in FIGS. 9-10 the dumpster 40 is illustrated in partially mocked-up form.

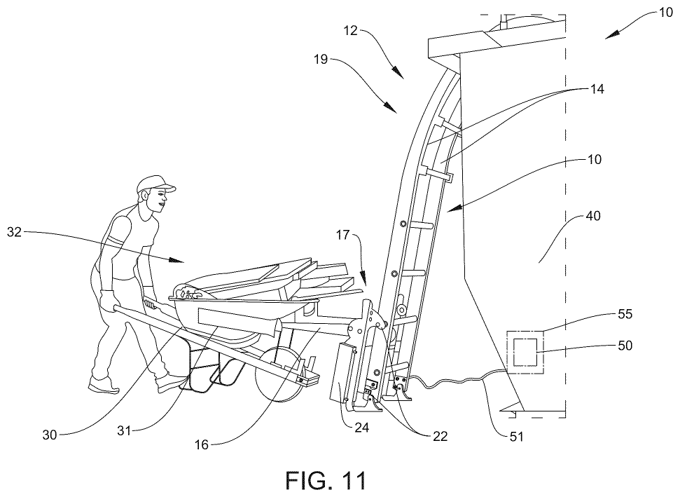

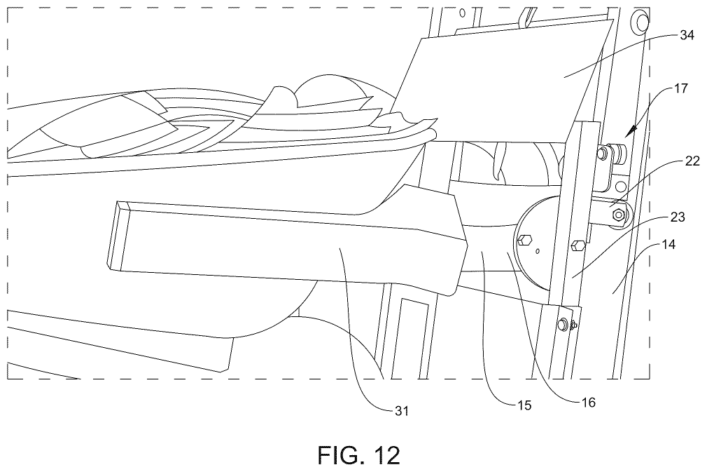

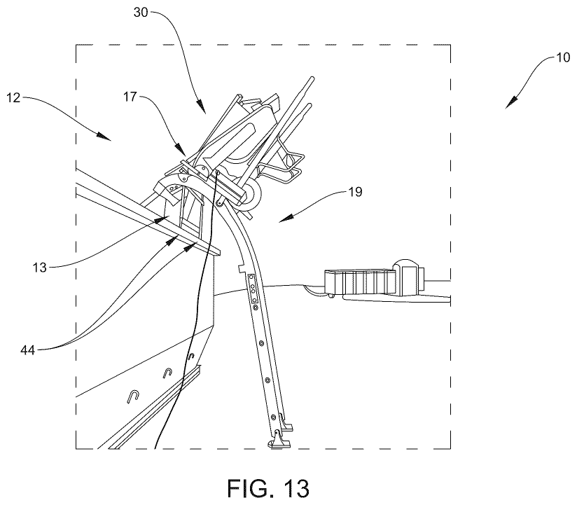

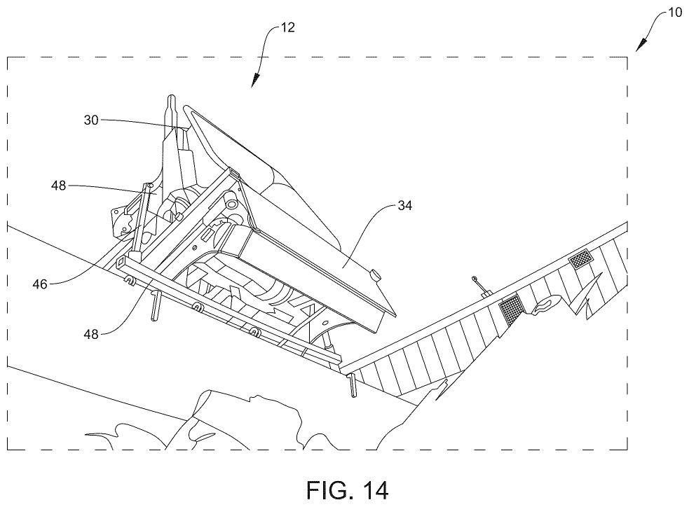

As illustrated with particular regard to at least FIG. 11 through FIG. 14, the wheelbarrow 30 may comprise one or more receptacles 31 configured to receive one or more corresponding members 15 of the docking portion 16 of the wheelbarrow 30. For example, without limitation, one of the receptacles 31 may be provided at each side of the wheelbarrow 30, such as along a debris holding portion (e.g., tub) thereof. The receptacles 31 preferably each define a through-channel. For example, without limitation, the receptacles 31 may each be closed on at least four side and/or open on a front and/or rear side thereof. The receptacles 31 may each be configured to each receive one of two of the corresponding members 15 which extend from, and/or form part of, the docking portion 16 of the lift 12. In this way, the wheelbarrow 30 may be selectively docketed with the lift 12 by manually advancing the wheelbarrow 30 forward so that the members 15 are received in the receptacles 31. Similarly, the wheelbarrow 30 may be selectively undocketed with the lift 12 by manually retracting the wheelbarrow 30 rearward so that the members 15 are removed from the receptacles 31. The receptacles 31 may hold the wheelbarrow 30 while it is lifted.

The lift 12 preferably comprises a vehicle 17 attached to the tracks 14. The vehicle 17 may comprise one or more batteries and/or motors 24, such as for powering the vehicle 17. The motor(s) 24 may be directly or indirectly attached to the wheel(s) 22 of the vehicle 17. Preferably, the wheels 22 engage, such as by inserting into, the tracks 14, such as to prevent, or help prevent, removal of the vehicle 17 from the tracks 14. For example, the wheels 22 may be located on exterior facing surfaces of the tracks 14 and be at least partially recessed in the same. This may limit travel of the vehicle 17 to along the tracks 14.

The motor(s) 24, batteries, and/or controller 52 may be provided locally at the vehicle 17, such as within one or more housings thereof. For example, without limitation, the vehicle 17 may comprise members 23 forming a support structure. Preferably, these members 23 extend along and/or between the tracks 14 when the vehicle 17 is mounted to the tracks 14, though various number and/or arrangement of members 23 may be utilized. The wheels 22 may be connected (directly or indirectly) to the members 23. The chute 34 may be connected (directly or indirectly) to the members 23. The docking portion 16, such as but not necessarily limited to, the member 15, may extend from the member 23. The motor(s) 24, batteries, and/or controller 52, along with any housing(s) for the same, may be attached to such members 23 of the support structure (directly or indirectly).

The vehicle 17 may move along the tracks 14 of the lifting structure 19. The lifting structure 19 may be attached to the dumpster and/or other waste receptacle 40. The lifting structure 19 may comprise an attachment substructure 13 for attaching the lifting structure 19 to the waste receptacle 40 (e.g., dumpster). The attachment substructure 13 may comprise some or all of the components of FIGS. 9-10 (e.g., height adjustment mechanism(s) 46, clamping device(s) 44, bracket(s) 48, and/or vertical member(s) 58).

The lifting structure 19 may include the tracks 14, the cross support(s) 21, and/or the attachment substructure 13.

The chute 34 may comprise one or more panels. The panel(s) may be moveably attached to the vehicle 17 and/or may be tethered thereto.

A remote control 55 or other device for operating the vehicle 17 may be in wired 51 and/or wireless connection with the vehicle 17, such as the controller 54 and/or motor(s) 24 thereof. In this way, operation of the vehicle 17 may be controlled from a distance, such as for safety reasons. The remote control 55 may comprise, provided, and/or form, at least in part, the controller 52 and/or the user interface 50, such as by way of physical buttons, touch screen, joystick and/or other human-machine-interface components located at the same.

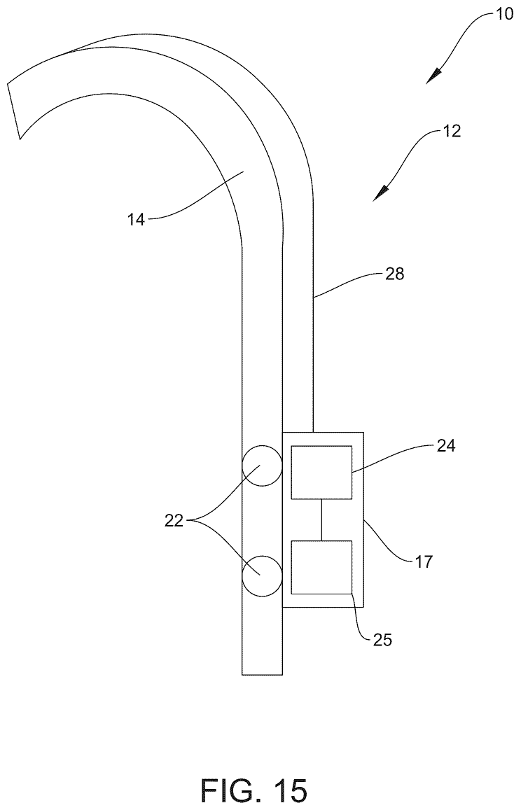

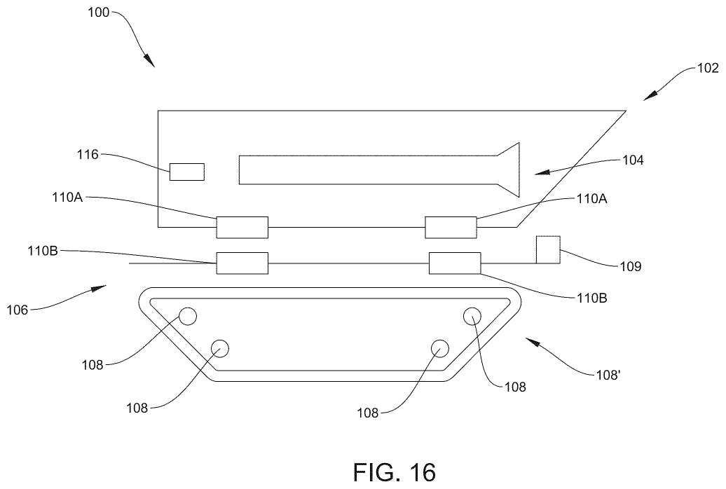

As illustrated with particular regard to at least FIG. 15, the vehicle 17, in exemplary embodiments, without limitation, may be conveyed along the tracks 14 by operation of an onboard motor(s) 24. A flexible linkage 28, such as but not necessarily limited to, a cable may be attached to an upper portion of the tracks 14, such as a distal end thereof and/or a final cross support 21, by way of non-limiting example. Alternatively, or additionally, the flexible linkage 28 may be connected to the attachment substructure 13.

The motor 24 and/or a redirection component 26 may act as and/or be part of a winch, by way of non-limiting example. The motor 24 and/or redirection component 26 may, when operated, wind the flexible linkage 28 about the redirection component 26 (e.g., spool) to cause the vehicle 17 to advance along the tracks 14. The tracks 14 and/or wheels 22 may guide progress of the vehicle 17. The motor(s) 24 may be powered by one or more onboard batteries 25 and/or other power supplies. Alternatively, or additionally, the motor(s) 24 are powered by electrically connected, but remote, power supplies (e.g., battery, utility power supply, generator, motor, fuel source, fuel cell, solar panel, combinations thereof, or the like). The motor 24, batteries 25, and/or wheels 22 may be interconnected by one or more members 23 and/or housing panels, which may form, at least in part, a support structure for the vehicle 17, in exemplary embodiments without limitation.

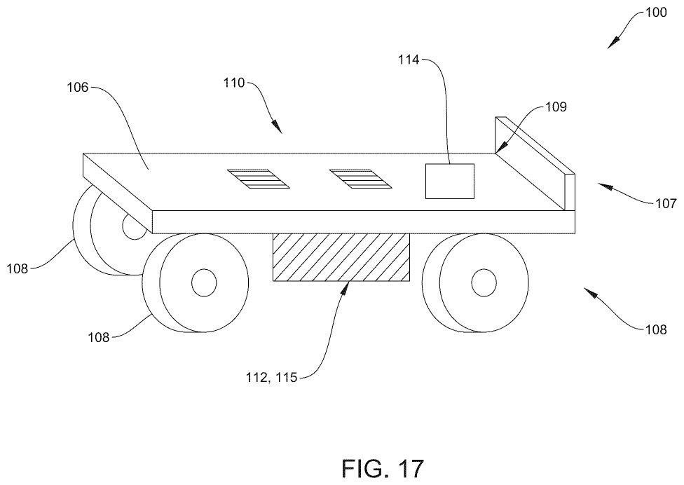

FIG. 16 and FIG. 17 illustrate exemplary autonomous guided vehicles (AGVs) 100 adapted for use at temporary job sites, such as construction sites, such as for roofing work. However, the AGVs 100 shown and/or described herein may be used at other job sites for other types of work. In exemplary embodiments, without limitation, the AGVs 100 are adapted for use with the system 10, the lift 12 and/or the dumpster 40, though such is not required. The AGV 100 may be considered part of the system 10 or separate therefrom.

The AGV 100 may comprise one or more material storage compartments 102. The compartments 102 may be generally sized and/or shaped as a wheelbarrow material storage area, though other sizes and/or shapes may be utilized. In exemplary embodiments, without limitation, the compartments 102 are detachable, such as by way of one or more attachment devices 110 installed at a deck 106 of the AGV 100 and/or at the compartment 102. Preferably, a first set of one or more attachment device components 110A is located at an upper surface of the deck 106 and a second, and mating set of one or more attachment device components 110B are located at a lower surface of the compartment 102. The first and second sets of attachment device components 110A, 110B may be alignment when the compartment 102 is adequately positioned. The first and second sets of attachment device components 110A, 110B may provide selective connection and disconnection of the compartment 102 from the deck 106, and thereby a remainder of the AGV 100. The attachment devices 110 may comprise magnets, hooks, pins and apertures, clamps, mating protrusions and recesses, threaded fasteners, motors or other components for actuating the same, combinations thereof, or the like. One or more physical obstructions 109 may be provided at the deck, such as protrusions, rails, inclined surfaces, grooves, combinations thereof, or the like, to guide the compartment 102 into position at the deck 106, such as for alignment of the first and second sets of attachment device components 110A, 110B.

The compartments 102 may be configured for automatic detachment upon docking of the AGV 100 with the dumpster lift 12, such as at the docking portion 16. For example, without limitation, the AGV 100 may comprise one or more forward mounted components or sensors 107. The forward mounted components or sensors 107 may form part of and/or be one of the attachment devices 110. For example, actuation of the forward mounted components or sensors 107 may be configured to trigger detachment of the attachment devices 110, such as by way of mechanical connection. To provide a more specific example, without limitation, the forward mounted components or sensor 107 may be mechanically actuated upon docking and the mechanical actuation may be mechanically translated (e.g., by linkage(s)) to mechanical disconnection of the first and second sets of attachment devices 110A, 110B. The forward mounted components or sensors 107 may optionally be provided at the one or more physical obstructions 109, though such is not necessarily required.

Alternatively, or additionally, the forward mounted components or sensors 107 may be in electronic communication with the attachment device 110, such as by way of a control subsystem 112. For example, the forward mounted components or sensors 107 may be configured to sense docking and signal the control subsystem 112 which may be configured to command detachment of the attachment devices 110 accordingly. The sensors or components 107 may comprise bumpers, buttons, proximity sensors, switches, RFID readers and/or tags, optical sensors, cameras, optically scannable codes (e.g., QR codes, bar codes, etc.), combinations thereof, or the like. While the forward mounted components or sensors 107 are sometimes shown and/or described as forward-mounted, they may be provided at other locations.

In exemplary embodiments, corresponding sensors and/or components for the forward mounted components or sensors 107 may be provided at the lift 12, such as at the docking portion 16 thereof where the AGV 100 is expected to dock. These may alternatively or additionally sense and/or confirm docking and may mechanically and/or electronically (e.g., by way of signal to the control subsystem 112) trigger detachment of the attachment devices 110. For example, without limitation, RFID readers and/or tags and/or optically scannable codes (e.g., QR codes, bar codes, etc.) may be provided so that a location of the AGV 100 at the lift 12 may be confirmed. As another example, without limitation, mechanical pushing against protrusions at the docking portion 16 may cause disconnection of the attachment devices 110.

Alternatively, or additionally, the compartment 102 may be manually detachable, such as by way of a lever, button, knob, or the like which may be mechanically connected to the attachment device 110. This may permit, for example without limitation, manual operation and/or override, such as in the case of sensor 107 error or failure.

Selective detachment of the compartment 102 may allow the compartment 102 to be detached and separately lifted by the lift 12, and the material (e.g., trash, debris) loaded therein to be dumped, thereby reducing lifting capacity needs and/or wear and tear for the lift 12. This may also allow various size, shape, and/or types of compartments 102 to be selectively loaded to the AGV 100, such as for accommodating various types and/or kinds of materials (e.g., trash for dumping, tools and/or construction materials for delivery, etc.).

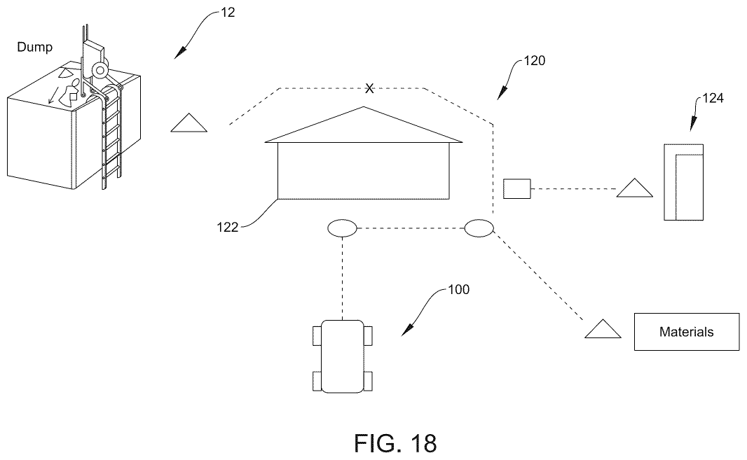

FIG. 18 illustrates the AGV 100 in exemplary use at an exemplary temporary job site. The AGV 100 may be configured to navigate using temporary path indicators 120 at the job site.

Such temporary indicators 120 may comprise tape, stickers, or other substrates (e.g., puck, medallion, or the like). The temporary indicators 120 may be encoded, such as by way of color, symbol, QR code, barcode, embedded information (e.g., RFID chip), combinations thereof, or the like. The size, direction, and/or shape of the temporary indicators 120 may alternatively or additionally serve to relay information (e.g., follow direction of tape, shape or nature of substrate indicating certain information). The color and/or symbol nature of the temporary indicators 120 and/or interpretation based on the size, direction, and/or shape thereof, by way of non-limiting example, may be particularly useful for temporary job sites as such material may be readily available and easily installed, removed, replaced and/or reconfigured. In one exemplary embodiment, without limitation, spray paint on a ground surface and/or laying tape may be sufficient to provide coded navigational guide to the AGV 100 in this regard.

The AGV 100 may be programmed, such as at the control subsystem 112, with the encoding (e.g., colors, symbols, size, direction, and/or shape of the temporary indicators 120) and may be configured to navigate according to the sensed temporary indicators 120. By way of non-limiting example, certain colors/symbols may indicate direction, speed, next action, combinations thereof, or the like. Such programming may be made by way of software code, lookup table, combinations thereof, or the like. Such programming may be periodically updated and/or user defined. Examples, without limitation, of such commands that may be communicated include the following: turn right, turn left, turn X degrees, move forward X inches/feet, move backwards X inches/feet, move forward at X mph, move rearward at X mph, move forward until next command, move rearward until next command, arrived at lift, arrived at destination, start of navigation, pause X second/minutes, search for navigation beacon, continue in present direction, wait for further command, combinations thereof, or the like. “X”, as used in this section, designates a variable, which may be user specified and/or predefined, and the units of measure described are merely exemplary and not intended to be limited.

Sensors 114 may be provided at the AGV 100 for such navigation. For example, a series of downward angled sensors 114 may be spaced apart along a lower surface or portion of the deck 106. Preferably, the AGV 100 includes a series of downward angled optical sensors for viewing temporary indicators 120 located below and/or somewhat forward of the AGV 100. Preferably, at least two, but less than 10, such optical sensors are located to face an underside of said deck 106 and/or space immediately forward of the AGV 100 (e.g., 5-15 feet, without limitation). The sensors 114 may be positioned in a spaced apart, preferably fanned, array. This may maximize the area of scanning for the navigation markers 120. The number, type, and/or arrangement of sensors may be varied.

In exemplary embodiments, the AGV 100 and/or lift 12 comprise sensors which enhance homing and docking at the lift 12. For example, without limitation, the AGV 100 may comprise such sensors at, or as part of, the forward mounted sensors or component 107 and may comprise homing beacon(s). Alternatively, or additionally, the docking portion 16 may comprise such homing beacon(s) or complementary homing beacon(s). The homing beacons may comprise non-directional beacons and/or be configured to emit and/or detect radio signals (e.g., WiFi, near field communication devices), acoustic signals (e.g., ultrasonic), optical signals (e.g., infrared), combinations thereof, or the like.

The AGV 100 may alternatively or additionally be configured to sense and/or operate with other navigational beacons, such as to create waypoints, virtual barriers or “no-go” zones, combinations thereof, or the like.

The temporary navigation markers 120 may allow the path of the AGV 100 to be quickly and easily installed, removed, and/or updated, which may be particularly useful for temporary job sites. The markers 120 may be installed to avoid obstacles 122, such as work areas, walls, or the like, or otherwise define a navigational pathway. The nature of the temporary markers 120 may make installation, update, and removal quick and efficient, which may be particularly important for a temporary job site.

The AGV 100 may additionally comprise various sensors 116 for autonomous, or semi-autonomous movement (e.g., cameras, machine vision software, proximity sensors, range finders, LiDAR, GPS, combinations thereof, or the like). Such sensor(s) 116 may be generally outward directed (e.g., forward, rearward, sides, etc.). The AGV 100 may additionally be preprogrammed, at least in part, to follow a predetermined path. Such autonomous or semi-autonomous and/or preprogrammed navigation may be used as an alternative to, and/or to enhance, the guided navigation and/or where unexpected conditions are encountered (e.g., obstacles, lack of temporary marker, etc.).

The AGV 100 may be provided with various ruggedization features, such as for better suitability for temporary construction sites which may be outdoors or otherwise have rough terrain. Such features may include, for example without limitation, wheels 108, treads 108′, shocks, sealed or partially sealed electronics and/or power supply compartments (e.g., at the control subsystem 112), combinations thereof, or the like.

The deck 106 may be connected to the wheels 108 (e.g., with or without treads 108′) such as by way of a chassis, frame, axels, and/or other known vehicular components.

The AGV 100 is preferably battery powered, supplied by wired and/or wireless charging. However, other fuel and/or power supplies may be utilized (e.g., gas, solar, etc.). The AGV 110 may comprise one or more power subsystems 115. The power subsystems 115 may comprise one or more batteries, one or more motors, combinations thereof, or the like. The power subsystems 115 may be directly connected to the wheels 108 and/or may be separate therefrom and mechanically connected thereto by one or more known vehicular components.

A charger 124 may be provided at the temporary job site configured to electrically charge the AGV 100. The charger 124 may optionally include one or more homing beacons and/or temporary indicators 120 may be provided for navigation to the charger. The charger 124 may include mating docking components for the AGV 100 and may be sensed by the AGV 100 similar to docking with the lift 10. The AGV 100 may be configured, such as by way of the control subsystem 112, to navigate to the charger when the power supply reaches a specific level (e.g., 20%, by way of non-limiting example) for automatic recharging.

The AGV 100 may be configured to communicate with elevator and/or gate control systems at the job site, for example, such as to improve navigation and accessibility to various locations of the job site. Such communication may be provided by way of wireless transmitters/receivers at the AGV 100 and such items (e.g., WiFi, near field communication), which are preferably encrypted and/or key coded.

The AGV 100 and/or storage compartments 102 thereof may comprise one or more structural features 104 adapted to dock with the lift 12. Such features 104 may comprise, by way of non-limiting example, protrusions, struts, slots, combinations thereof, or the like, which may be configured to mate with, by way of non-limiting example, protrusions, struts, slots, combinations thereof, or the like of the docking portion 16 of the lift 12. These features 104 may provide a mating relationship to temporarily secure the compartment 102 at the lift 12 during operations of the lift 12. In an exemplary embodiment, without limitation, the structural features 104 comprise a channel located on left and right sides of the compartment 102, each configured to receive a protruding member of the lift 12. The structural features 104 may be the same, or similar to, the receptacles 31 of the wheelbarrow 30 and the mating protruding members of the lift 12 may be, or may be similar to, the member 15 of the lift 12. In this way, the compartment 102 of the AGV 100 may be docked in the same or similar fashion as shown and/or described with regard to at least FIGS. 11-14 herein, without limitation. However, the compartment 102 is preferable, but optionally, detached from the AGV 100 during the lifting and dumping process before being reattached so that the AGV 100 may perform other operations.

The AGV 100 may be transportable between job sites, such as in a full-size pickup truck bed, though such is not required. Various size, shape, and/or weight AGVs 100 which are transportable by various size, shape and/or type of vehicles may be utilized.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention.

Certain operations described herein may be performed by one or more electronic devices. Each electronic device may comprise one or more processors, electronic storage devices, executable software instructions, combinations thereof, and the like configured to perform the operations described herein. The electronic devices may be general purpose computers or specialized computing devices. The electronic

Vehicle for Temporary Job Sites, Such as for use with Automated Wheelbarrow Lifts devices may comprise personal computers, smartphone, tablets, databases, servers, or the like. The electronic connections and transmissions described herein may be accomplished by wired or wireless means. The computerized hardware, software, components, systems, steps, methods, and/or processes described herein may serve to improve the speed of the computerized hardware, software, systems, steps, methods, and/or processes described herein. The electronic devices, including but not necessarily limited to the electronic storage devices, databases, controllers, or the like, may comprise and/or be configured to hold, solely non-transitory signals.

What is claimed is:

1. A portable and adaptable material handling autonomous guided vehicle (“AGV”)
for temporary job sites, said AGV comprising:
wheels;
a deck;
a compartment for receiving materials; and
one or more attachment components for detachably securing the compartment to said deck.

2. The AGV of claim 1 wherein:
said one or more attachment components comprise a first set of attachment components located at a lower portion of the compartment and a second set of attachment components located at an upper portion of the deck.

3. The AGV of claim 2 wherein:
said one or more attachment components comprise one or more of: magnets, hooks, pins and apertures, clamps, mating protrusions and recesses, threaded fasteners, and motors.

4. The AGV of claim 2 further comprising:
one or more structural features, each adapted to mate with a corresponding portion of a docking portion of a lift for the compartment of the AGV.

5. The AGV of claim 4 wherein:
said one or more structural features comprise receptacles, each located at a side of the compartment and configured to receive one of a corresponding number of protruding members of the docking portion of the lift when the AGV is docked.

6. The AGV of claim 4 further comprising:
a power subsystem mechanically connected to, and configured to selectively power, the wheels; and
a control subsystem in electronic connection with, and having operative control over, said power subsystem.

7. The AGV of claim 6 further comprising:
a tread system comprising said wheels.

8. The AGV of claim 6 further comprising:
one or more forward mounted sensors wherein said control subsystem is configured to receive data from said one or more forward mounted sensors and operate said one or more attachment components based, at least in part, on the data.

9. The AGV of claim 8 wherein:
the one or more forward mounted sensors comprise one or more of: bumpers, buttons, proximity sensors, switches, RFID readers, RFID tags, optical sensors, cameras, and optically scannable code.

10. The AGV of claim 8 further comprising:
one or more physical obstructions located at the deck for guiding the compartment into position at the deck to align the first set of attachment components with the second set of attachment components.

11. The AGV of claim 10 wherein:
the one or more physical obstructions comprise protrusions, rails, inclined surfaces, and grooves; and
the one or more forward mounted sensors are provided at the one or more physical obstructions.

12. The AGV of claim 8 further comprising:
one or more navigational sensors.

13. The AGV of claim 12 wherein:
said one or more navigational sensors comprise one or more of: cameras, machine vision software, proximity sensors, range finders, LiDAR, and GPS devices.

14. The AGV of claim 13 wherein:
a subset of said one or more navigational sensors are spaced apart along a lower portion of the deck and face downward or at a downward angle for viewing temporary navigational markers located below and/or somewhat forward of the AGV.

15. A system for material handling at a temporary job site, said system comprising:
the AGV of claim 1; and
a lift comprising tracks having a hook shaped upper portion for temporary securement to a dumpster, a docking portion comprising wheels secured to said tracks, and a motor for moving the docking portion along the tracks, wherein said docking portion is configured to receive the compartment for lifting and dumping the materials deposited therein within the dumpster by operation of said motor.

16. A system for material handling at a temporary job site, said system comprising:
the AGV of claim 8; and
a lift comprising tracks having a hook shaped upper portion for temporary securement to a dumpster, a docking portion comprising wheels secured to said tracks, and a motor for moving the docking portion along the tracks, wherein said docking portion is configured to receive the compartment for lifting and dumping the materials deposited therein within the dumpster by operation of said motor;
wherein the control subsystem is configured to cause release of the one or more attachment devices where the data from the one or more forward mounted sensor indicate successful docking of the AGV with the docking portion of the lift.

17. A method for material handling at a temporary job site, said method comprising:
providing the system of claim 16 at the temporary job site;
securing the lift to the dumpster; and
loading the compartment of the AGV with the materials.

18. The method of claim 17 wherein:
the temporary job site comprises a residential roofing job site; and
the materials comprise roofing materials.

19. A system for material handling at a temporary job site, said system comprising:
the AGV of claim 14;
a lift comprising tracks having a hook shaped upper portion for temporary securement to a dumpster, a docking portion comprising wheels secured to said tracks, and a motor for moving the docking portion along the tracks, wherein said docking portion is configured to receive the compartment for lifting and dumping the materials deposited therein within the dumpster by operation of said motor; and
the temporary navigational markers for arrangement at the temporary job site to guide the AGV to the dumpster, wherein temporary navigational markers are of different type, and wherein the control subsystem is configured to cause operations of said AGV in accordance with the type of temporary navigational marker last detected.

20. A method for material handling at a temporary job site, said method comprising:
providing the system of claim 19 at the temporary job site;
securing the lift to the dumpster;
arranging the temporary navigational markers around obstacles at the temporary job site between a material deposit point and the dumpster; and
loading the compartment of the AGV with the materials.
